(19) United States
(12) Patent Application Publication
(10) Pub. No.: US 2007/0116627 A1
(43) Pub. Date: May 24, 2007

(54) Carbon nanotube compositions and devices and methods of making thereof

(75) Inventors: Charles Patrick Collier, Pasadena, CA (US); Jinyu Chen, Pasadena, CA (US)

Correspondence Address: FOLEY AND LARDNER LLP;SUITE 500, 3000 K STREET NW, WASHINGTON, DC, 20007, US

(73) Assignee: California Institute of Technology

(21) Appl. No.: 11/337,711

(22) Filed: Jan. 24, 2006

Related U.S. Application Data
(60) Provisional application No. 60/646,696, filed on Jan. 25, 2005.
(60) Provisional application No. 60/717,100, filed on Sep. 14, 2005.

(51) Int. Cl. D01F 9/12; B32B 9/00

(52) U.S. Cl. 423/447.2; 977/745; 423/447.1; 977/742; 977/847

(57) ABSTRACT

In one embodiment, a stable aqueous solution contains carbon nanotubes non-covalently functionalized with organic electro-optically active molecules, such as planar, anionic porphyrin molecules. A device containing carbon nanotubes directly functionalized with planar, anionic porphyrin molecules in a free base form may be formed using the solution as the nanotube source or the device may be formed using another method. In another embodiment, a method of spatially orienting nanostructures, such as nanotubes, includes providing a solution or a suspension containing nanostructures over a first surface of a first substrate, and combing the solution or suspension in a first direction to orient the nanostructures in the first direction over the substrate.

### CROSS-REFERENCE TO RELATED PATENT APPLICATIONS

This application claims benefit of priority of U.S. Provisional Applications Ser. Nos. 60/646,696 filed on Jan. 25, 2005 and 60/717,100, filed on Sep. 14, 2005. The above mentioned applications are incorporated herein by reference in its entirety.

### BACKGROUND

The present invention is directed to solid state devices which include carbon nanotubes, to carbon nanotube compositions and to methods of making the devices.

The unique structural, mechanical and electronic properties of carbon nanotubes, such as single wall carbon nanotubes (SWNTs), have made these promising materials for device fabrication. In order to effectively utilize SWNTs as building blocks for nanotechnology, spatial control over nanotube orientation and location is desirable. There are two general strategies for gaining spatial control of SWNTs. In the direct-growth strategy, nanotube length, location and orientation can be controlled using pre-pattered catalyst and chemical vapor deposition (CVD). In the post-growth strategy, nanotubes can be aligned by various methods, including biomolecular recognition, manipulation by an atomic force microscope (AFM) tip, application of an electric field or a magnetic field, deposition on chemically patterned surfaces, alignment by gas-flow or dip-coating washing. For many applications it is important that the inherent functionality of the carbon nanotubes not be altered or destroyed by high temperature CVD, covalent chemical functionalization steps or various applied fields.

### SUMMARY

One embodiment of the invention provides a stable aqueous solution comprising carbon nanotubes non-covalently functionalized with organic electro-optically active molecules.

Another embodiment of the invention provides a device comprising carbon nanotubes directly functionalized with planar, anionic porphyrin molecules in a free base form.

Another embodiment of the invention provides a method of spatially orienting nanostructures, comprising providing a solution or a suspension containing nanostructures over a first surface of a first substrate, and combing the solution or suspension in a first direction to orient the nanostructures in the first direction over the substrate.

### BRIEF DESCRIPTION OF THE DRAWINGS

FIGS. 1A, 1B and 1C show absorption spectra of porphyrin/SWNT aqueous solutions (solid lines) and pure porphyrin solutions containing no SWNTs (dashed lines) for various wavelength ranges.

FIG. 2A is a plot of optical absorbance of the porphyrin free base (filled squares), diacid (filled triangles), J-aggregates (open circles), and SWNTs (open triangles) as functions of volume of added acid (0.2N HCl) to a porphyrin/SWNT solution. A

FIG. 2B is a plot of a ratio of the diacid absorbance over that of the free base as a function of added HCl.

FIGS. 3A, 3B and 3C show the absorption spectra from the titrations that generated the trends shown in FIG. 2A.

FIG. 4A is plot of normalized absorption and fluorescence emission spectra of porphyrin/SWNT solution (dashed line) and solution containing only porphyrin (solid line).

FIG. 4B is a plot of a normalized absorption (solid line) and excitation (dashed line) spectra taken from the same porphyrin/SWNT solution.

FIG. 5 is an AFM image of an individual SWNT.

FIGS. 6A and 6B are schematic illustrations of steps in a method of combing SWNTs on a substrate. The glass coverslip in FIG. 6A is placed at the far edge of the SWNT suspension and slid along the direction of the arrow, which results in the alignment of SWNTs on the substrate, as shown in FIG. 6B.

FIGS. 7A and 7C show AFM topography scans and FIGS. 7B and 7D show line profiles of aligned SWNTs on mica. The height profiles of the aligned nanotubes in FIGS. 7A and B are measured to be less than 1 nm, suggesting they are from individual nanotubes. The scans and profiles in FIGS. 7C and 7D are from another sample, in which a nanotube bundle is aligned parallel to individual SWNTs.

FIG. 8 shows AFM height images of aligned SWNTs after two combing procedures were carried out on a mica surface. Black arrow 1 is the first combing direction, and white arrow 2 is the subsequent combing direction.

FIG. 9 is a plot of transmitted light intensity as a function of polarization angle for polarized light illuminating a glass surface combed with aligned nanotubes. An angle of zero degrees corresponds to the polarized direction of the light being perpendicular to the combing direction.

FIGS. 10A-10D are schematic illustrations of steps in a method of combing nanotubes on a stamp and then stamping the nanotubes to a substrate.

FIG. 11A shows an AFM height image of aligned SWNTs combed onto a PDMS stamp and then transferred to silicon wafer for a bare SWNT array.

FIG. 11B shows an AFM height image of aligned SWNTs combed onto a PDMS stamp and then transferred to silicon wafer for a porphyrin functionalized SWNT array made by the method of the first embodiment.

FIG. 12 shows an AFM height image (20 μm×20 μm) of aligned SWNTs crossbar networks formed by transferring combed SWNTs from a PDMS stamp onto a silicon wafer twice in perpendicular directions.

### DETAILED DESCRIPTION OF THE EMBODIMENTS

In the first embodiment of the invention, the inventors have developed a stable carbon nanotube aqueous solution. In a second embodiment of the invention, the inventors have developed a method of spatially orienting nanostructures, such as nanotubes, which includes combing a nanostructure containing solution or suspension in one direction to orient the nanostructures in the same direction.

### First Embodiment

The first embodiment provides a stable carbon nanotube aqueous solution. The aqueous solution contains water as the solvent rather than an organic solvent. A water solvent may be suitable for more device applications and may have more positive environmental characteristics than an organic solvent. The solution remains stable for more than one week, such as for several weeks, for example for two to four weeks. The term “stable” as used herein means that the nanotubes do not precipitate out of the solution for more than a week in substantial quantities. For example, the nanotubes do not precipitate out of the solution for more than a week in quantities that may be observable by the unaided eye. Preferably, but not necessarily, the solution contains substantially no surfactant (i.e., the solution contains no surfactant or it contains a trace amount of surfactant which is insufficient to materially affect the properties of the solution) to further increase the number of applications for the solution and to improve the environmental characteristics of the solution.

In the solution, the carbon nanotubes are non-covalently functionalized with organic electro-optically active molecules. The organic electro-optically active molecules provide electro-optical properties which allow the functionalized nanotubes to be used in light emitting devices, such as light emitting diodes (including organic light emitting diodes) and bio-markers (where the organic molecules emit radiation, such as visible, UV or IR radiation when exposed to an external stimulus while the nanotubes bind to a target analyte), and photovoltaic devices, such as solar cells and photodetectors.

Preferably, the organic molecules comprise electro-luminescent dye molecules, such as porphyrin molecules which are directly, non-covalently bonded to the carbon nanotubes. The term “directly bonded” means that the porphyrin molecules are bonded to the nanotubes without an intermediate linker molecule. For example, the porphyrin molecules are bonded to the nanotubes without using pyrene linker molecules to link the nanotubes to the porphyrin molecules. The direct bonding is advantageous because it simplifies the structure and the processing method (i.e., the nanotubes may be functionalized in a one step functionalization method rather than in a two step functionalization method used for indirect bonding). The term “non-covalently bonded” means that the predominant bonding between the porphyrin molecules and the nanotubes does not include covalent bonds. For example, the predominant bonding between the porphyrin molecules and the nanotubes may comprise van der Waals type bonding. The non-covalent bonding is advantageous because the inherent functionality of the carbon nanotubes is not altered or destroyed by valent chemical functionalization. Functionalization of nanotubes with porphyrins may supply the nanotubes with many of the porphyrin's unique intrinsic properties, such as electro-luminescence, photovoltaic properties and biocompatibility.

Any suitable porphyrin molecules which solubilize carbon nanotubes to provide a stable aqueous nantoube solution may be used. Preferably, the porphyrin molecules comprise planar, anionic (i.e., negatively charged) porphyrin molecules. The planarity and negative charge are believed to facilitate the bonding of the porphyrin molecules to the nanotubes and to facilitate the solubization of the nanotubes in the aqueous solution.

Furthermore, the non-covalently bound porphyrin molecules are preferably in a free base form. In other words, at least some porphyrin molecules bound to the nanotubes are in the base form rather than in the acid (i.e., diacid) form and do not contain a metal ion inserted in the middle (i.e., the cavity) of the porphyrin ring structure. Preferably, a majority, such as 51-100%, for example, 70 to 90% of the porphyrin molecules bound to the nanotubes are in the free base form.

Most preferably, the porphyrin molecules comprise water-soluble, free base form of the meso-(tetrakis-4-sulfonatophenyl) porphine (abbreviated as H₂TPPS⁴⁻) molecules. However, other suitable porphyrin molecules may also be used.

Preferably, the carbon nanotubes comprise single walled carbon nanotubes (SWNTs). However, other carbon nanotubes, such as multi-walled carbon nanotubes (MWNTs) can also be used. The nanotubes may have any chirality, and comprise semiconducting or metallic nanotubes or a mixture of both types of nanotubes.

Thus, in a preferred aspect of the first embodiment, water-soluble porphyrin molecules, meso-(tetrakis-4-sulfonatophenyl) porphine, solubilize individual single-walled carbon nanotubes (SWNTs), resulting in aqueous solutions that are stable for several weeks without covalent chemical functionalization of the nanotubes, or the use of surfactants.

As will be described in more detail below, the porphyrin-nanotube complexes have been characterized with UV-visible absorption and fluorescence spectroscopy as functions of pH, and with atomic force microscopy (AFM). Without wishing to be bound by a particular theory, the present inventors believe that the porphyrin/SWNT interaction is selective for the free base form. In other words, the present inventors believe that the free base form of the porphyrin selectively interacts with the nanotubes and is mainly responsible for solubilizing them in water. The interaction with the SWNTs inhibits the protonation of the free base to the diacid. In contrast, under mildly acidic conditions, nanotube-mediated J-aggregates form. The J-aggregates are unstable in solution and result in precipitation of the nanotubes over the course of a few days.

Furthermore, the fluorescent properties of the free base and diacid forms of H₂TPPS⁴⁻ are not significantly perturbed by the nanotubes, but the emission from the J-aggregates is completely quenched. Finally, the solubilization procedure allows the alignment of individual nanotubes on a substrate or on a stamp by a combing procedure that will be described in the second embodiment.

The following is a non-limiting illustrative example of preparing and characterizing an aqueous nanotube solution. It should not be considered limiting on the scope of the claims. While a particular type of porphyrin and nanotubes are described in the illustrative example, the claimed invention should not be considered limited to the specific materials of the illustrative example.

The porphyrin meso (tetrakis-4-sulfonatophenyl) porphine (Scheme 1) was purchased from Frontier Scientific as the dihydrochloride salt of the diacid (H₄TPPS²⁻). SWNTs (HiPco® from Carbon Nanotechnologies) were used as received without further purification. Millipore water (18 MΩ) was used throughout. HCl (aq) was from J. T. Baker and NH₄OH (aq) was from E.M.D. Chemicals.

After addition of SWNTs (0.1 mg), the porphyrin solutions (0.6 mg/mL, 25 mL) were ultrasonicated for thirty minutes to one hour (ULTRASonik 57×) and left standing for two to three days. 100 μL of the supernatant of this solution was carefully removed by pipette and diluted to 6 mL for UV-visible absorption (Uvikon 933) or diluted by an additional factor of 10 for fluorescence measurements (ISS K2), or drop cast on silicon wafers for AFM imaging (MultiMode with Nanoscope IV controller, Digital Instruments). The silicon substrates had been previously cleaned with “piranha” solution (3:7 (v/v) mixture of 30% H₂O₂ and H₂SO₄). Tapping mode AFM images were taken of the porphyrin/SWNT complexes prepared from a dilute freshly-mixed solution (pH=4.66) drop cast onto a silicon wafer. The images show mainly individual SWNTs, although some nanotube bundles were also found on the surface.

The addition of the H₄TPPS²⁻ salt to pure water is believed to result in an equilibrium between the diacid and free base forms of the porphyrin (pKa₁=4.86, pKa₂=4.96), which is pH dependent. Both forms have characteristic absorption bands (Soret and Q-bands) that can be used to quantify their relative concentrations. Under strongly acidic conditions (pH<7), or in the presence of various cationic species, J-aggregates of H₄TPPS²⁻ can form, which exhibit an intense narrow absorption band at 490 nm.

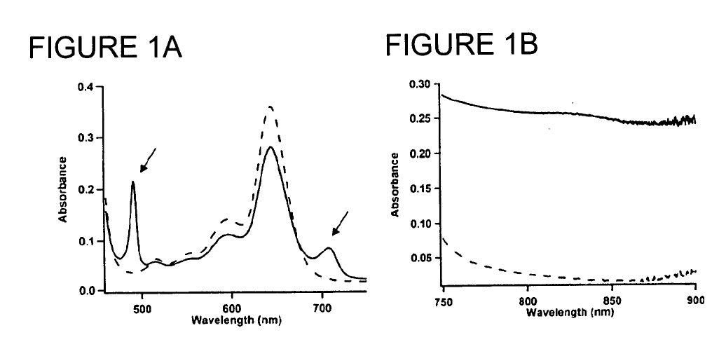

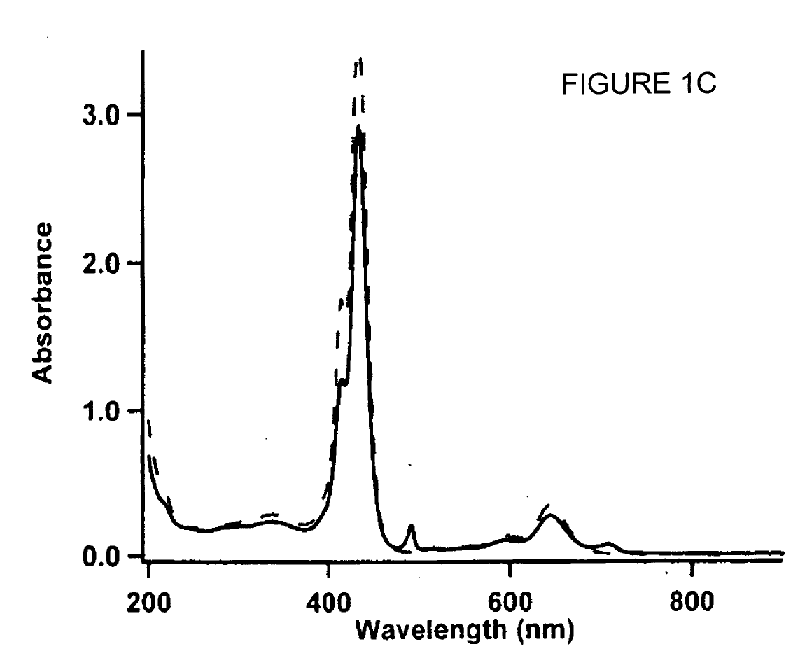

FIGS. 1A-1C show absorption spectra of porphyrin/SWNT aqueous solutions (solid lines) and pure porphyrin solutions containing no SWNTs (dashed lines) (i.e., used a reference/comparative example). The UV-vis absorption spectrum from 460 nm to 750 nm from an aqueous solution of H₄TPPS²⁻ co-dispersed with SWNTs (pH=4.66) is shown as the solid line in FIG. 1A. The arrows indicate that peaks due to J-aggregates are observed only in the porphyrin/SWNT solution.

FIG. 1B shows the spectra from 750 to 900 nm, indicating the presence (solid line) or absence (dashed line) of soluble SWNTs. The porphyrin/SWNT solution concentrations used in FIG. 1B were 15 times greater than in FIG. 1A.

The new peaks at 492 nm and 712 nm in FIG. 1A in the presence of the SWNTs are believed to be due to J-aggregates that have nucleated on the nanotubes. These peaks are clearly absent from the solution not containing SWNTs (dashed line). Their absence can be correlated with the lack of features in the 700-900 nm wavelength range in FIG. 1B (dashed line), while the solution containing SWNTs has broad adsorption throughout this range, due to the characteristic van Hove transitions of the nanotubes.

FIG. 1C shows a survey spectrum covering the 200-900 nm wavelength range. This figure shows the positions of the Soret absorption band of the free base at 413 nm and the peaks belonging to the diacid at 435 nm and 646 nm. The positions of these bands were not perturbed by interactions with the nanotubes, as seen by comparison to the spectrum from an aqueous solution containing the same concentration of porphyrin (at the same pH) but with no SWNTs (dashed line).

The J-aggregate/SWNT complexes were not stable in solution. After about one day, both the absorption peak at 490 nm and the broad absorption at 750-900 nm dropped to about ¼ of their original intensity. These spectral changes were correlated with the appearance of black flocs that precipitated out of solution. The loss of the J-aggregate absorption did not correspond to a transition from the aggregate state to free base or diacid in solution since the peaks corresponding to the free base and diacid absorption did not change significantly.

The precipitates were collected on a cellulose acetate membrane (0.22 μm pore size, Coming) using vacuum filtration. The membrane was washed continuously with pure water until the washes became colorless and then dried in a dessicator at room temperature for two days. The membrane was cut into strips, re-immersed in pure water and subject to ultrasonication for two hours, resulting in a grayish supernatant with some residual dark green material left on the membrane strips and walls of the glass vial. The UV-vis absorption spectrum of this redispersed solution (pH=6.66) showed the presence of SWNTs coexisting only with free base porphyrins, with no diacid or J-aggregates. The absorption spectrum of the filtrate (pH=4.38) on the other hand consisted of peaks from the free base and diacid, but without SWNTs or J-aggregates.

Without wishing to be bound by a particular theory, the inventors believe that this evidence indicates that the free base form of H₄TPPS²⁻ selectively binds to SWNTs and renders them soluble in aqueous solution, rather than the diacid or other forms (note that the free base form of H₄TPPS²⁻ is H₂TPPS⁴⁻). This conclusion is further supported by adjusting the pH of a fresh porphyrin solution with NH₄OH (aq) before mixing with SWNTs to quantitatively drive the acid/base equilibrium toward the free base. The absorption spectrum of this solution (pH=7.1) is believed to show the presence of only free base porphyrin and SWNTs.

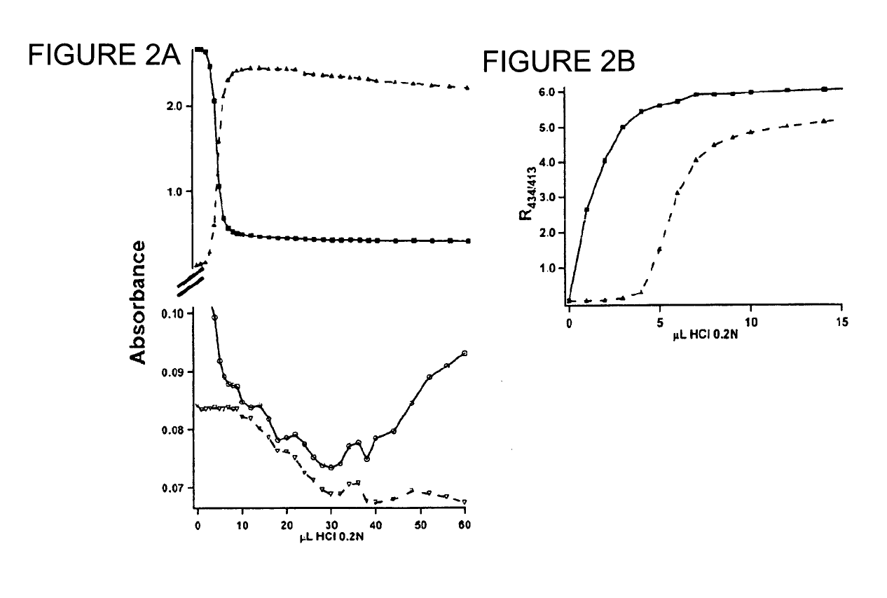

The pH dependence of the porphyrin/SWNT interactions may be investigated in more detail by monitoring the absorption spectra of the redispersed solution as a function of titration with 0.2 N HCl (aq). The trends in the optical signatures of the porphyrin free base, diacid, J-aggregates, and SWNTs are plotted relative to each other in FIG. 2A. Specifically, FIG. 2A illustrates trends in the optical absorbance of the porphyrin free base (filled squares), diacid (filled triangles), J-aggregates (open circles), and SWNTs (open triangles) as functions of volume of added acid (0.2 N HCl) to a porphyrin/SWNT solution.

As shown in FIG. 2A, before addition of HCl (initial pH=6.66, initial volume=6 mL), only the porphyrin free base and SWNT optical signatures are seen. Titration with 10 μL of acid is enough to quantitatively convert the free base form (monitored at 413 nm) to the diacid (434 nm).

However, the onset of the diacid absorption was significantly delayed relative to that of an identically prepared control solution (same initial pH) lacking SWNTs. This can be seen in FIG. 2B, which is a plot of a ratio of the diacid absorbance over that of the free base as a function of added HCl. Specifically, FIG. 2B shows the ratios of the absorbance maxima of the diacid (434 nm) to the free base (413 nm) as functions of added acid for porphyrin/SWNT solution (dashed line) and pure porphyrin solution containing no SWNTs (solid line). The interactions of the free base with the co-dispersed nanotubes results in more HCl(aq) being required to protonate the porphyrin to the diacid form.

Without wishing to be bound by a particular theory, the present inventors believe that there are two reasons for this difference. First, the association of the free base with the nanotubes decreases the accessibility of the unprotonated nitrogen atoms in the porphyrin core for attack by hydronium ions. Second, it is known that the average equilibrium structure of the H₂TPPS⁴⁻ porphyrin molecule in the free base state is planar while the pyrrole rings in the diacid form are tilted significantly away from planarity. It is plausible that interactions with the μ-network of the SWNT sidewalls stabilize the planar free base form. This reasoning is also consistent with the finding described above that the free base form specifically associates with and solubilizes the SWNTs in water. As the diacid optical signature grows in intensity and the free base absorption decreases, the absorption due to the solubilized SWNTs also decreases.

Additional HCl aliquots result in the formation of J-aggregates, monitored at 490 nm. The decrease in the absorption at 490 nm between 10 and 30 μL added HCl is believed not to be associated with the optical signature from J-aggregates, but is believed to be due to the decrease of the high frequency edge of the Q-band of the free base. As the J-aggregate signal grows in intensity from 30 to 60 μL added HCl, the diacid absorption decreases and the SWNT absorption stays roughly constant, consistent with a picture involving aggregation of diacid monomers onto nanotubes at low pH. The absorption signals from the J-aggregate/SWNT complexes drops somewhat after this solution is left standing for 12 hours due to precipitation (final pH=2.4), but not to the extent of the original dispersion made without adding excess acid or base (pH=4.66), which suggests that the solubility of these nanocomposites may be pH dependent.

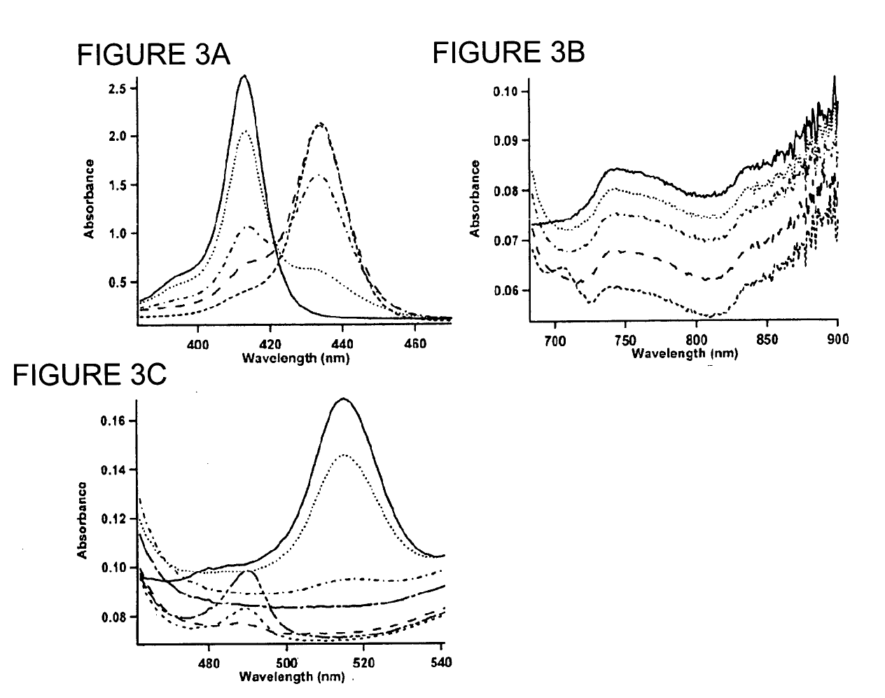

The absorption spectra from the titrations that generated the trends shown in FIG. 2A are shown in FIGS. 3A, 3B and 3C. Specifically, FIGS. 3A-3C show changes in absorption features of porphyrin/SWNT solutions as functions of titration with 0.2N HCl (aq) from 0 to 60 μL. The solid lines in FIGS. 3A-3C correspond to initial spectra before addition of HCl. FIG. 3A shows the transition from the free base optical absorption to that of the diacid. FIG. 3B shows changes in the optical absorption of the SWNTs. FIG. 3C shows the growth of the absorption band at 490 nm corresponding to the formation of J-aggregates.

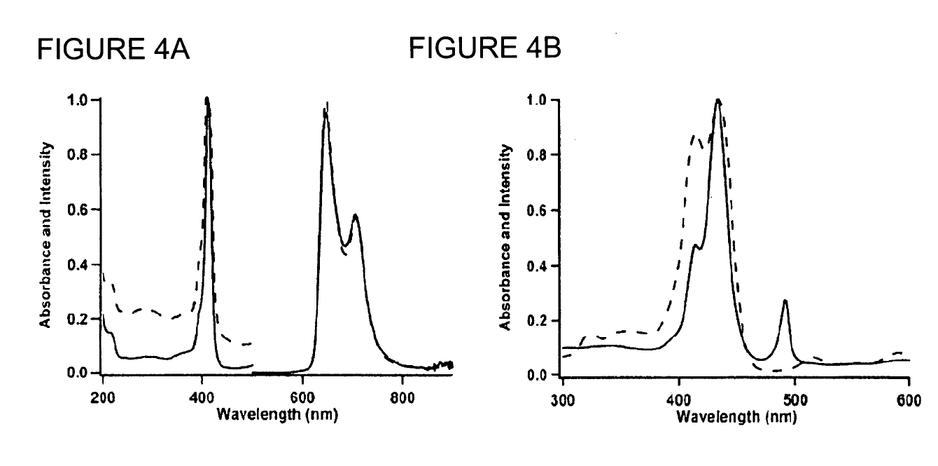

FIG. 4A is plot of normalized absorption and fluorescence emission spectra of porphyrin/SWNT solution (dashed line) and solution containing only porphyrin (solid line). FIG. 4B is a plot of a normalized absorption (solid line) and excitation (dashed line) spectra taken from the same porphyrin/SWNT solution. The excitation spectrum was monitored at 700 nm.

Fluorescence spectra were acquired from an as-prepared porphyrin-SWNT solution, the re-dispersed solution and a control solution containing porphyrins but no SWNTs. All three solutions exhibited strong fluorescence in the 625-750 nm wavelength region when excited at 413 nm corresponding to emission from the free base and the diacid, but no fluorescence was observed from J-aggregates.

FIG. 4A shows absorption and fluorescence emission spectra of the porphyrin/SWNT redissolved complex and a solution of pure porphyrin, normalized for concentration (7.8 μM, based on the extinction coefficient of the Soret band, ε₄₁₃=500,000 M⁻¹ cm⁻¹) and prepared at identical pH (6.9). The normalized fluorescence profile of the porphyrin/SWNT redissolved solution was approximately the same as that of pure porphyrin, indicating that the interactions with the nanotubes did not significantly quench or otherwise perturb the emission from the free base or the diacid.

FIG. 4B shows absorption and fluorescence excitation spectra taken within minutes of each other from a fresh porphyrin-SWNT solution (pH=4.66). The excitation spectrum was monitored at 700 nm, which is near the emission maximum for J-aggregates of H₄TPPS²⁻. The intense peak at 490 nm from the J-aggregates is evident in the absorption spectrum, but is completely absent in the excitation spectrum. Apparently, efficient energy transfer to the nanotubes completely quenches fluorescence from the J-aggregates. This suggests that the aggregates are in more intimate contact with the nanotube sidewalls, presumably through strong μ-μ interactions. It is believed that one reason why this quenching is not seen for the free base and diacid is that these forms, and in particular the free base form, associate with the SWNTs more through long-range electrostatic interactions, and are not as tightly bound to the nanotubes as the J-aggregates.

Without wishing to be bound by a particular theory, it is believed that the trends in the optical absorption and fluorescence spectra as functions of pH illustrate the nature of the interactions of the various forms of the porphyrin with carbon nanotubes. The free base of the porphyrin (H₂TPPS⁴⁻) has the combination of planarity of the porphyrin ring and the highest negative charge density from the anionic sulfonate groups, which makes it the most effective form at dispersing and stabilizing individual SWNTs in solution. The diacid form (H₄TPPS²⁻) is nonplanar and has less negative charge, and stabilizes SWNTs in water to a lesser extent, as seen by the decreased optical absorption from the nanotubes at lower pH in FIG. 2A. Finally, J-aggregates, once nucleated, can form insoluble precipitates by diffusion limited aggregation with an average size on the order of hundreds of nanometers.

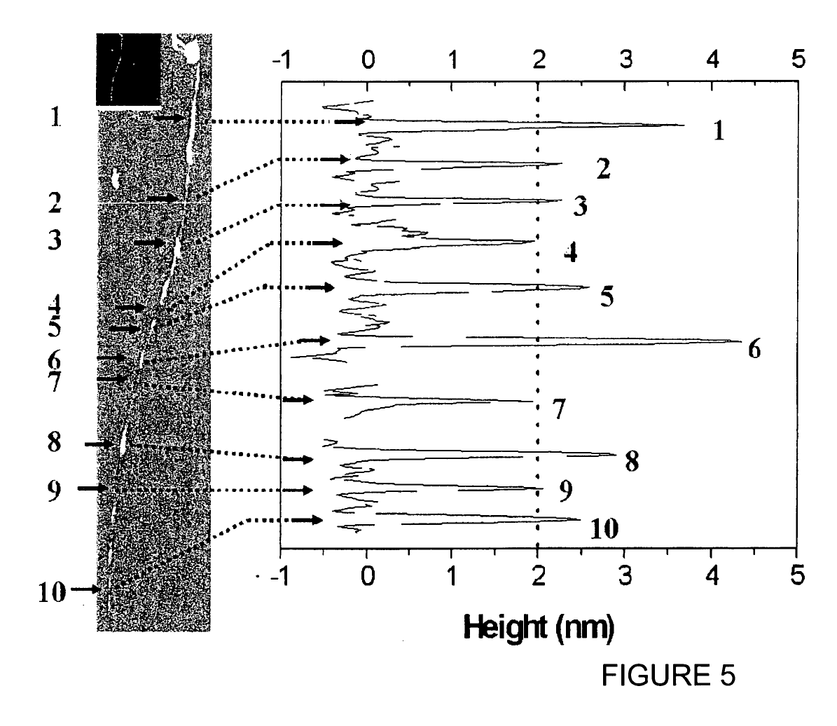

FIG. 5 shows an AFM height image of an individual SWNT uniformly decorated with “bumps” which are assigned to porphyrin aggregates. Arrows in the figure are used to point out regions that gave height profiles varying from 2.0-4.2 nm for the bumps and 0.7-1.6 nm for the bare regions, which are within the range of the reported SWNT diameters produced by the HiPco® process.

Thus, absorption and fluorescence measurements of aqueous solutions of the water-soluble porphyrin H₂TPPS⁴⁻ complexes with SWNTs indicate that the free base form is primarily responsible for rendering the nanotubes soluble in water, while the stabilizing interactions with the tubes makes it more difficult to protonate the porphyrin to the diacid form. J-aggregates nucleate on the nanotubes under mildly acidic conditions (pH5). Thus, it is preferred to form the functionalized nanotubes in non-acidic solutions, such as solutions having a pH above 6, such as a pH of between 7 and 14. Efficient energy transfer between the J-aggregates and the nanotubes results in complete quenching of fluorescence while emission from the free base and the diacid remains largely unaffected.

The above method may be used to form a device comprising carbon nanotubes, such as SWNTs, directly, non-covalently functionalized with planar, anionic porphyrin molecules in a free base form, such as H₂TPPS⁴⁻ molecules. Any device in which nanotubes can be used may be formed, such as a solar cell, a photodetector, a light emitting device, a bio-marker, a memory device or a logic device. In the memory or logic devices, the nanotubes may function as transistors or as interconnects or electrodes. The nanotubes may be formed in a cross bar array architecture as will be described with respect to the second embodiment below.

### Second Embodiment

In a second embodiment, a method of spatially orienting nanostructures, includes providing a solution or a suspension containing the nanostructures over a first surface of a first substrate, and combing the solution or suspension in a first direction to orient the nanostructures in the first direction over the substrate.

Any suitable nanostructure may be used, such as carbon nanotubes. The term “carbon nanotubes”, as used herein, refers to single-walled carbon nanotubes, multi-walled carbon nanotubes, carbon nanofibers, or other carbon nanostructures. However, other nanostructures, such as nanowires, nanobelts, etc. whether made of carbon or another material, such as gold, gallium arsenide, zinc oxide, nickel oxide, etc. may also be used.

The step of combing comprises moving an instrument through the suspension or solution in the first direction to orient and align the nanostructures, such as the nanotubes, lengthwise in the first direction using a drag force. This provides aligned nanotubes combed on a substrate. The term “comb” means the sliding of the instrument through a suspension or solution of nanostructures, such as carbon nanotubes on a substrate. In one example of “combing”, a glass coverslip or plate can be slid through the suspension or solution of carbon nanotubes on a substrate. Any other suitable instrument which can align nanotubes by a drag force may be used instead of a coverslip, such as an instrument which has a plate or comb shape. Any suitable material other than glass, such as plastic, metal, semiconductor and/or ceramic, may be used for the instrument. In a preferred embodiment, the substrate is glass, silicon, mica, or a PDMS stamp that is seated flat. The drag forces acting at the surface of the substrate near the point of contact with the sliding instrument align the nanotubes along the sliding direction. Combing can result in nanotubes that are uniformly aligned in one direction. Repeating the process, which include dispersal and combing of a nanotube suspension or solution on the already nanotube combed surface but in a different direction, can lead to a new set of aligned nanotubes oriented at a desired precise angle relative to the first set of aligned nanotubes.

The nanostructures may be located in any suitable suspension or solution. For example, the nanotubes may be located in the stable carbon nanotube aqueous solution in which the nanotubes are non-covalently functionalized with H₂TPPS⁴⁻ molecules of the first embodiment. Any suitable solvent, such as water or an organic solvent may be used. Several known techniques can be used to form a nanotube suspension or solution, including ultrasonication and dispersion of nanotubes in organic solvents.

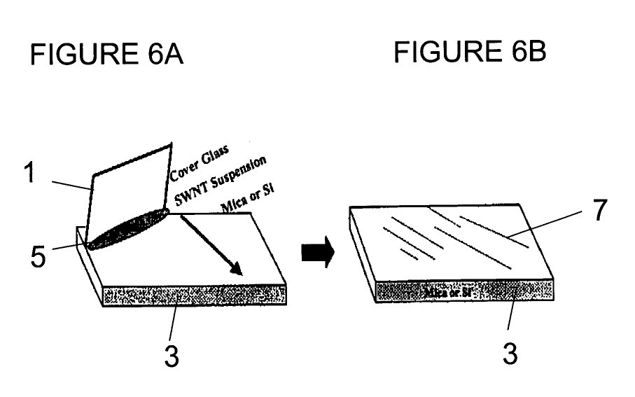

In a first aspect of the second embodiment, the method comprises a combing method and the substrate comprises a final device substrate on which the nanotube or other nanostructure containing device is fabricated. As shown in FIG. 6A, the instrument 1 is placed at a starting point over the substrate 3 and is slid through the solution or suspension 5 along the direction of the arrow. This results in the alignment of nanostructures 7 on the substrate 3, as shown in FIG. 6B.

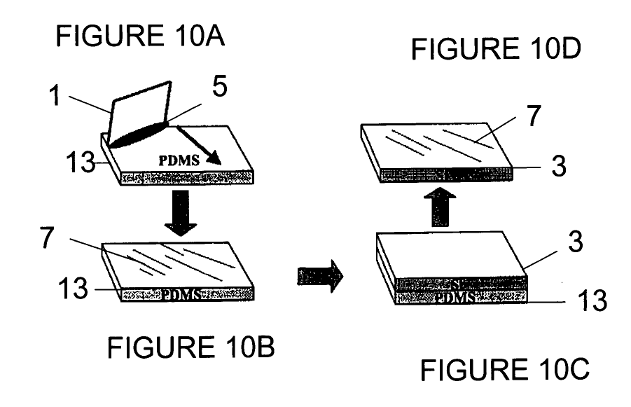

In a second aspect of the second embodiment, the method comprises a combing and stamping method and the first substrate comprises a stamp. In this case, after the combing step, a first surface of a substrate (i.e., the first surface of the stamp) is placed in contact with a first surface of a second substrate to transfer the oriented nanostructures to the first surface of the second substrate. In this case, the second substrate may be the final device substrate. Preferably, the stamp and the second (device) substrate are contacted such that the transferred nanotubes are oriented and aligned in a desired direction on the first surface of the second substrate. As shown in FIG. 10A, the instrument 1 is placed at a starting point over the stamp 13 and is slid through the solution or suspension 5 along the direction of the arrow. This results in the alignment of nanostructures 7 on a surface of the stamp 13, as shown in FIG. 10B. The nanostructure containing surface of the stamp 13 is then placed in contact with the substrate 3, as shown in FIG. 10C. The aligned nanostructures 7 are transferred to the surface of the substrate 3, as shown in FIG. 10D. This process may be repeated to form a cross-bar array of nanostructures 7.

In one non-limiting example, the nanotubes comprise SWNTs, the first substrate comprises a PDMS stamp and the second substrate comprises a semiconductor substrate. Thus, another aspect of the second embodiment of the invention provides a PDMS stamp for manufacturing nanotube-based products. The PDMS stamp is patterned and can transfer nanotubes to different substrates. Because the PDMS industry is relatively mature, making delicately patterned PDMS stamps for combing and stamping nanotube-based products can be done cost-effectively.

In the combing step, a droplet of nanotube solution or suspension is combed onto a surface such as mica, glass, silicon, or PDMS. The nanotube orientation and alignment can be controlled along the “combing” direction. In the stamping step, the aligned nanotubes on the surface can be efficiently transferred onto other flat surfaces, such as silicon and mica. This approach enables the fabrication of massive and hierarchical nanotube assemblies.

The combing and stamping procedure can be used to form any desired nanotube-based structures. First, nanotubes are deposited and combed on a PDMS stamp. The combed PDMS surface is then brought in contact with a substrate, or the substrate is placed on the surface of the PDMS stamp. The substrate can be silicon or mica, but is not limited to those surfaces. For example, the PDMS surface is in contact with the substrate for approximately 30 minutes. However, the contact time can vary between 15 minutes and 1-3 hours. A pressure may be applied to the stamp and/or the substrate to transfer the nanotubes. The previously aligned nanotubes are transferred from the PDMS stamp to the substrate. Hierarchical nanotube assembly can be easily controlled by multiple repeated stamping operations. Any suitable devices, including the devices described with respect to the first embodiment, may be formed.

For example, a nanotube cross bar array may be formed. In general, a method of making a nanotube cross bar array may include placing a first stamp comprising a plurality of oriented and aligned first carbon nanotubes and a substrate in contact with each other to transfer the plurality of first carbon nanotubes to the substrate such that the plurality of first carbon nanotubes are oriented and aligned in a first direction on the substrate, as shown for example in FIGS. 10B-10D. The method also includes forming a plurality of second carbon nanotubes oriented and aligned in a second direction different from the first direction on the substrate to form a carbon nanotube cross bar array. The nanotubes on the first stamp may be aligned by the combing method shown in FIG. 10A or by any other nanotube deposition or post-growth manipulation method which forms aligned nanotubes,

In one aspect of this embodiment, the first stamp and the substrate are placed in contact with each other in a first angular arrangement to transfer the first nanotubes. The same first stamp and the substrate are then placed in contact with each other in a second angular arrangement different from the first angular arrangement to transfer the second nanotubes. For example, by placing the same PDMS stamp on the substrate more than once in different (such as orthogonal or other non-parallel directions), a nanotube cross bar network can be effectively constructed. Using this approach, cross bar arrays of aligned, long nanotubes can be obtained. Long, aligned nanotubes can be functionalized, and the combing and stamping process does not substantially alter the functionalized sites. The nanotubes in the array may be rotated from each other by 1 to 90 degrees.

Alternatively, a plurality of second carbon nanotubes oriented and aligned in a different direction than the first carbon nanotubes are provided on the first stamp. The first stamp is then placed in contact with the substrate for a second time. In this case, rather than rotating the stamp and the substrate relative to each other in a different way during each stamping step, the nanotubes are aligned in a different direction on the stamp prior to each stamping step. This can be accomplished by providing a first solution or suspension containing the first carbon nanotubes over the stamp, and combing the first solution or suspension in a first combing direction to orient the first carbon nanotubes in the first combing direction over the stamp. The first stamping step is then performed. Thereafter, a second solution or a suspension containing the second carbon nanotubes is provided over the same stamp. The second solution or suspension is then combed in a different, second combing direction to orient the second carbon nanotubes in the second combing direction over the stamp. The second stamping step is then performed.

Alternatively, a different, second stamp comprising a plurality of oriented and aligned second carbon nanotubes is placed in contact with the substrate after the placing the first stamp in contact with the substrate. In other words, two different stamps are used to form the cross bar array. The different stamps containing aligned nanotubes are contacted with the substrate in such a way as to form non-parallel arrays of nanotubes (i.e., the nanotubes may be aligned in a different direction on each stamp and/or each stamp may be rotated relative to the substrate in a different way to obtain non-parallel arrays of nanotubes).

The following illustrative examples should not be considered limiting on the scope of the claims.

### EXAMPLE 1

### Combing Method

Single-walled carbon nanotubes (HiPco™, CNI) were used as received without further purification. 1,2-ortho-dichlorobenzene (o-DCB) was purchased from Acros. A silica wafer and #1 glass cover slip were cleaned with “piranha” solution ((3:7 (v/v) mixture of 30% H₂O₂ and H₂SO₄). The mica was freshly cleaved prior to use. PDMS (Dow Coming Sylgard Silicone Elastomer-182) was cleaned with an oxygen plasma cleaner (Harrick Scientific, Ossing, N.Y.) for 10 minutes before use.

A SWNT suspension preparation of 0.5 mg SWNTs was dispersed in 15 mL o-DCB by ultrasonication for 2 hours (ULTRASonik 57×). After the suspension was left standing for three days, 1 mL of the supernatant was drawn out and diluted to 10 mL, and used in the combing procedure. Tapping mode AFM imaging was performed with a MultiMode with Nanoscope IV controller from Digital Instruments (Santa Barbara, Calif.). BS-multi 75 Si tips with spring constant of 3 N/m (Nanosensors) were used.

A 50 micro-liter droplet of the as-diluted SWNT suspension was pipetted onto one side of the substrate (silicon, mica or PDMS stamp) that was seated flat. Then a glass coverslip was placed at the far edge of the drop and slid over the surface, as illustrated in FIG. 6A. The glass coverslip was placed at the far edge of the SWNT suspension and “combed” along the direction indicated by the arrow to from aligned nanotubes illustrated in FIG. 6B.

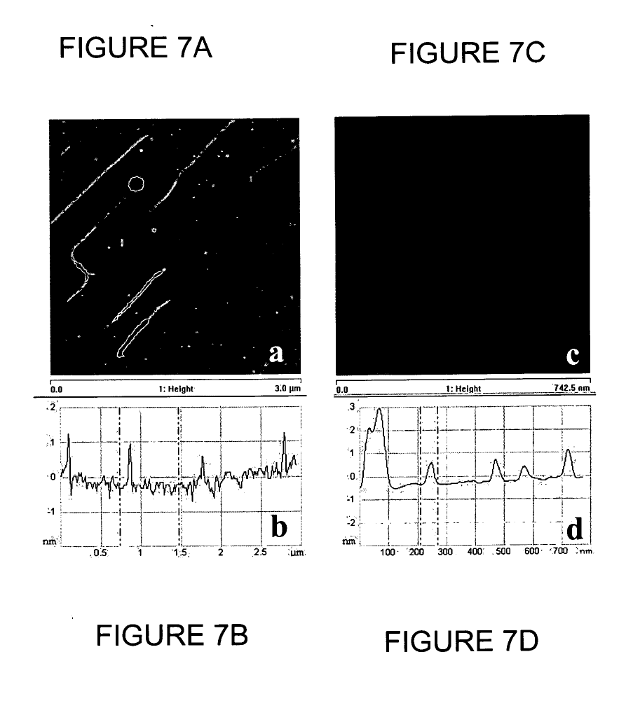

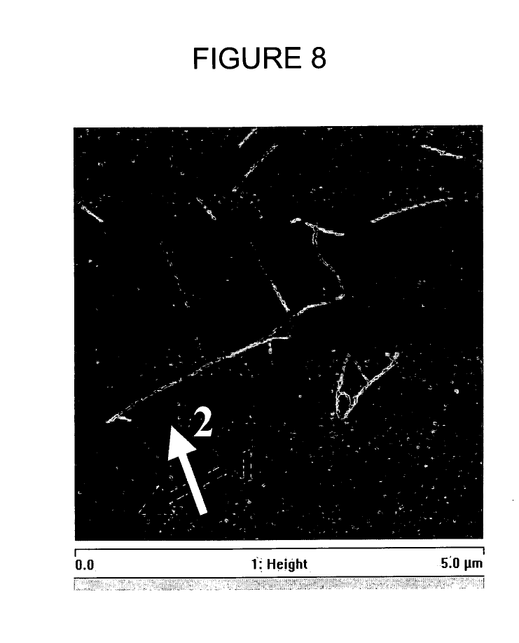

FIG. 7A is an AFM image of combed SWNTs on a mica surface. The nanotubes are uniformly aligned in one direction—the combing direction. The cross section profile is shown in FIG. 7B. The measured heights of the nanotubes are less than 1 nm, indicating they are individual single wall nanotubes. The image and line profile in FIGS. 7C and 7D show that both the bundle of nanotubes and individual single wall nanotubes are directed parallel to each other. FIG. 8 shows that parallel arrays of nanotubes are extended over the entire combed surface. A 20 micron×20 micron AFM image of aligned SWNTs on a silicon substrate is shown.

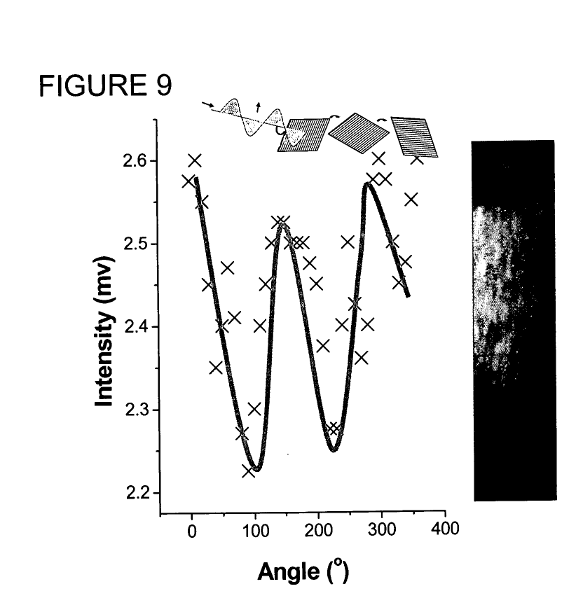

In FIG. 9, a combed glass surface was illuminated with polarized light from a lamp, and the light intensity transmitted through the substrate was recorded as a function of rotation angle of the polarizer relative the fixed glass substrate. The lowest transmitted light intensity coincided with the polarization direction running parallel to the combing direction, while the strongest intensity was obtained when the polarized direction was oriented perpendicular to the combing direction. The transmitted light intensity was fit to a cosine function of the rotation angle of the polarizer, which indicated that the carbon nanotubes were aligned parallel on the substrate at large scale. The modulation of the transmitted light with polarization angle in this case was due to scattering and absorption of the light from the aligned nanotube network, which was greatest when the polarization of the light was parallel to the alignment direction of the nanotubes. This modulation was not seen for samples where nanotubes were dispersed on a glass surface and alignment was attempted with directed gas flows instead of by combing as described here.

### EXAMPLE 2

### Combing and Stamping Method

“Combing and stamping” were performed by generally following the combing steps provided in Example 1. First, the nanotubes were combed as shown in FIGS. 10A and 10B to obtain the aligned nanotubes on a PDMS stamp. The combed side of the PDMS stamp was brought in contact with a silicon wafer or mica substrate for approximately half an hour, as shown in FIG. 10C. The aligned nanotubes were then transferred to the silicon or mica substrate, as shown in FIG. 10D.

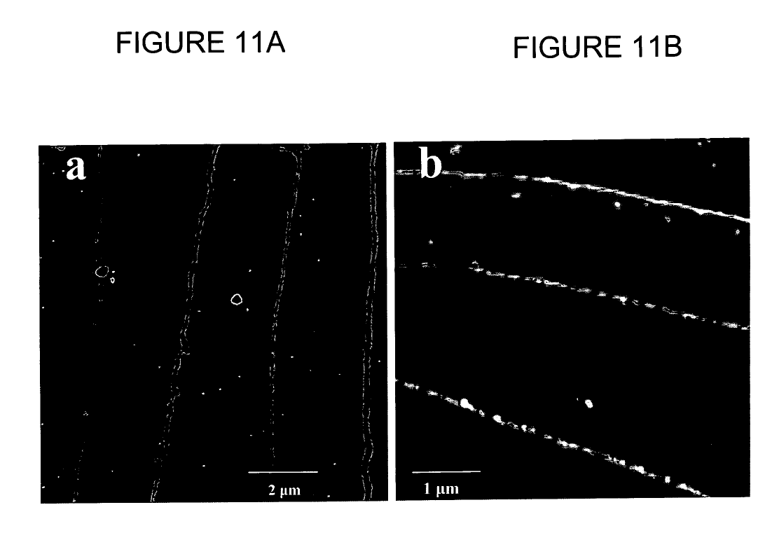

FIGS. 11A and 11B show examples of transferred parallel arrays of nanotubes on silicon. The array in FIG. 11A is made by first combing the SWNT-o-DCB suspension on PDMS and then stamping to the silica surface. Relatively long nanotubes are successfully aligned.

FIG. 1B shows an array of SWNTs noncovalently functionalized with porphyrin molecules, in which the bumps are anchored porphyrin aggregates. The combing and stamping procedure did not modify the functionalized sites. One drop (50 μL) of the H₄TPPS²⁻/SWNT aqueous solution was pipetted onto the surface of a clean PDMS stamp that had been pretreated in an oxygen plasma cleaner (Harrick) prior to use. A glass coverslip was placed at the far edge of the drop and slid over the surface as shown in FIG. 10A. The drag forces acting at the surface of the stamp aligned the nanotubes along the sliding direction. After the PDMS surface had been allowed to dry in air, it was contacted to a clean silicon wafer for 1 hour. With this step, the pre-aligned porphyrin/SWNTs were transferred to the silicon wafer. FIG. 11B is a typical tapping mode AFM image of aligned SWNTs on silicon, which show that the porphyrin aggregates remain attached to the SWNTs.

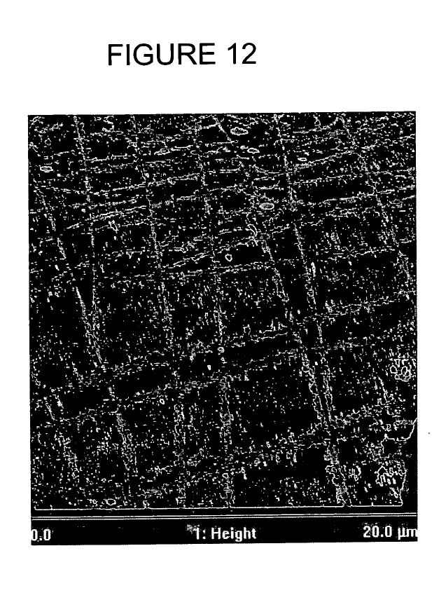

FIG. 12 shows that an extended nanotube crossbar network can be built when the PDMS stamp is placed twice on the silicon wafer covered with a thin layer of native oxide, each time for half an hour, along orthogonal directions. As shown, extended nanotube crossbar arrays can be easily obtained.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description of the preferred embodiments were chosen in order to explain the principles of the invention and its practical application, and are not meant to be limiting on the scope of the claims. It is intended that the scope of the invention be defined by the claims appended hereto, and their equivalents.

What is claimed is:

1. A stable aqueous solution comprising carbon nanotubes non-covalently functionalized with organic electro-optically active molecules.

2. The solution of claim 1, wherein the molecules comprise porphyrin molecules which are directly, non-covalently bonded to the carbon nanotubes.

3. The solution of claim 2, wherein the porphyrin molecules comprise planar, anionic porphyrin molecules in a free base form.

4. The solution of claim 3, wherein the solution contains substantially no surfactant.

5. The solution of claim 3, wherein the porphyrin molecules comprise H₂TPPS⁴⁻ molecules.

6. The solution of claim 5, wherein the solution remains stable for more than one week.

7. The solution of claim 5, wherein the nanotubes comprise SWNTs.

8. A device comprising carbon nanotubes directly, non-covalently functionalized with planar, anionic porphyrin molecules in a free base form.

9. The device of claim 8, wherein the porphyrin molecules comprise H₂TPPS⁴⁻ molecules and the nanotubes comprise SWNTs.

10. The device of claim 8, wherein the device comprises a solar cell, a photodetector, a light emitting device, a bio-marker, a memory device or a logic device.

11. A method of spatially orienting nanostructures, comprising:
providing a solution or a suspension containing the nanostructures over a first surface of a first substrate; and
combing the solution or suspension in a first direction to orient the nanostructures in the first direction over the substrate.

12. The method of claim 11, wherein the nanostructures comprise carbon nanotubes.

13. The method of claim 12, wherein the step of combing comprises moving an instrument through the suspension or solution in the first direction to orient and align the nanotubes lengthwise in the first direction using a drag force.

14. The method of claim 12, wherein the nanotubes are located in a suspension.

15. The method of claim 12, wherein the nanotubes are located in a solution.

16. The method of claim 15, wherein the nanotubes are non-covalently functionalized with H₂TPPS⁴⁻ molecules and the solution comprises a stable aqueous solution.

17. The method of claim 11, further comprising placing the first surface of the first substrate in contact with a first surface of a second substrate to transfer the oriented nanostructures to the first surface of the second substrate.

18. The method of claim 13, further comprising placing the first surface of the first substrate in contact with a first surface of a second substrate to transfer the oriented and aligned nanotubes to the first surface of the second substrate, such that the transferred nanotubes are oriented and aligned in a desired direction on the first surface of the second substrate.

19. The method of claim 18, wherein the nanotubes comprise SWNTs, the first substrate comprises a PDMS stamp and the second substrate comprises a semiconductor substrate.

20. A method of making a nanotube cross bar array, comprising:
placing a first stamp comprising a plurality of oriented and aligned first carbon nanotubes and a substrate in contact with each other to transfer the plurality of first carbon nanotubes to the substrate such that the plurality of first carbon nanotubes are oriented and aligned in a first direction on the substrate; and
forming a plurality of second carbon nanotubes oriented and aligned in a second direction different from the first direction on the substrate to form a carbon nanotube cross bar array.

21. The method of claim 20, wherein the step of placing a first stamp comprises placing the first stamp and the substrate in contact with each other in a first angular arrangement and the step of forming a plurality of second carbon nanotubes comprises placing the first stamp and the substrate in contact with each other in a second angular arrangement different from the first angular arrangement.

22. The method of claim 20, wherein the step of forming a plurality of second carbon nanotubes comprises placing a second stamp comprising a plurality of oriented and aligned second carbon nanotubes in contact with the substrate.

23. The method of claim 20, wherein the step of forming a plurality of second carbon nanotubes comprises providing the plurality of second carbon nanotubes oriented and aligned in a different direction than the first carbon nanotubes on the first stamp and placing the first stamp in contact with the substrate.

24. The method of claim 23, further comprising:
providing a first solution or suspension containing the first carbon nanotubes over the first stamp;
combing the first solution or suspension in a first combing direction to orient the first carbon nanotubes in the first combing direction over the first stamp prior to the step of placing the first stamp;
providing a second solution or suspension containing the second carbon nanotubes over the first stamp after the step of placing the first stamp; and
combing the second solution or suspension in a second combing direction to orient the second carbon nanotubes in the second combing direction over the first stamp prior to the step of forming the plurality of second carbon nanotubes on the substrate.

25. The method of claim 20, further comprising:
providing a first solution or suspension containing the first carbon nanotubes over the first stamp; and
combing the first solution or suspension in a first combing direction to orient the first carbon nanotubes in the first combing direction over the first stamp prior to the step of placing the first stamp.

26. The method of claim 25, wherein the first solution or suspension comprises a stable carbon nanotube aqueous solution.
